(19) United States
(12) Patent Application Publication
(10) Pub. No.: US 2026/0281789 A1
(43) Pub. Date: Sep. 17, 2026

(54) Entities and methods for efficient data collection in mobile core networks

(71) Applicant: HUAWEI TECHNOLOGIES CO., LTD., Shenzhen (CN)

(72) Inventors: Wint Yi Poe, Munich (DE); Riccardo Trivisonno, Munich (DE); Qing Wei, Munich (DE); Priyanka Pathak, Munich (DE)

(73) Assignee: HUAWEI TECHNOLOGIES CO., LTD., Shenzhen (CN)

(21) Appl. No.: 19/674,528

(22) Filed: May 12, 2026

Related U.S. Application Data
(63) Continuation of application No. PCT/EP2023/081616, filed on Nov. 13, 2023.

(51) Int. Cl. H04W 28/02; H04W 8/18

(52) U.S. Cl. CPC H04W 28/0221; H04W 8/18

(57) ABSTRACT

A network entity for providing a subscription service in a mobile network is disclosed. The network entity, which may be itself a network function of the mobile network, is configured to receive from a network function a subscription request for notification reports of the subscription service. Moreover, the network entity is configured to provide notification reports to the network function with a time-varying reporting periodicity and/or a time-varying reporting validity time window. The network entity allows increasing the signaling load efficiency of the network operations and procedures by adjusting the adaptive reporting periodicity and/or the adaptive reporting validity time window over time and, thereby, for instance preventing unnecessary notification reports for the subscription request.

### CROSS-REFERENCE

This application is a continuation of International Application No. PCT/EP2023/081616, filed on Nov. 13, 2023, the disclosure of which is hereby incorporated by reference in its entirety.

### TECHNICAL FIELD

The present disclosure relates to wireless communications. More specifically, the present disclosure relates to entities and methods for efficient data collection in mobile communication networks, including core networks of mobile communication networks.

### BACKGROUND

In mobile communication networks (or short mobile networks), e.g., 5G or 5G-A networks, network operations often require subscription and notification service operations. By way of example, these network operations may be, but are not limited to QoS monitoring, Analytics and Exposure network operations. Usually, the subscription and notification service operations require exhaustive data collection, monitoring and reporting features. These exhaustive features require both communication and computational resources, wherein the communication resources usually include the signaling related to the data collection and reporting while the computational resources include the resources for measurement, event detection, monitoring and data processing.

The subscription and notification service operations are a mandatory and basic operation for 5G or 5G-A networks. The associated signaling load and data traffic varies infrequently to very frequently depending on the associated notification mechanisms. Basically, periodic or event-based notification is used. Generally, a higher signaling load is expected in the periodic-based notification than the event-based notification. If the notification is required frequently or very frequently, reducing the amount of signaling load in one service operation can positively impact the overall signaling load. On the other hand, reducing the amount of the signaling load should not have a negative impact on the requirements for serving the subscription request. Hence, it is important to improve the overall signaling load without any impact to the requirements of the subscription request, for instance, a requested or required accuracy level of the subscription request.

The efficiency of the signaling load is related to the network energy consumption. Basically, the improvement of the signaling load efficiency can improve the energy efficiency and/or energy saving. For 6G mobile communication networks, energy saving and energy efficiency is a key criteria to be considered in architecture, procedures and operations.

### SUMMARY

It is an objective of the present disclosure to provide improved entities and methods for efficient data collection in mobile communication networks, including core networks of mobile communication networks.

The foregoing and other objectives are achieved by the subject matter of the independent claims. Further implementation forms are apparent from the dependent claims, the description and the figures.

According to a first aspect a network entity for providing a subscription service in a mobile network is provided. In an in an embodiment the network entity may be a network function of the mobile network.

The network entity according to the first aspect is configured to receive from a network function (herein also referred to as consumer network function) a subscription request for notification reports of the subscription service provided by the producer network function. Moreover, the network entity according to the first aspect is configured to provide notification reports to the network function with a time-varying, i.e. adaptive reporting periodicity (which may also be expressed as a reporting frequency) and/or a time-varying, i.e. adaptive reporting validity time window. The network entity according to the first aspect allows to increase the signaling load efficiency of the network operations and procedures by adjusting the adaptive reporting periodicity and/or the adaptive reporting validity time window over time and, thereby, for instance preventing unnecessary data collection or notification reports for the subscription request. Therefore, the network entity according to the first aspect may improve the energy efficiency and energy savings in a mobile communications network, in particular a 5G-A or 6G mobile communication network.

In an embodiment, the subscription request is a request for notification reports with a time-varying reporting periodicity and/or a time-varying reporting validity time window. Thus, a new type of subscription request in a mobile network is provided.

In an embodiment, the subscription request comprises an indication for notification reports with a time-varying reporting periodicity and/or a time-varying reporting validity time window. In an embodiment, the indication may be the indication “adaptive notification mode” Thus, the subscription request may indicate the request for an adaptive notification mode.

In an embodiment, the subscription request comprises one or more of the following: an initial reporting periodicity, a desired accuracy related to the subscribed request, a desired energy efficiency information, a desired energy consumption information, and/or a desired data sensitivity level.

In an embodiment, the network entity is configured to determine the time-varying reporting periodicity and/or the time-varying reporting validity time window. Thus, the network entity itself may determine the time-varying reporting periodicity and/or the time-varying reporting validity time window.

In an embodiment, the network entity is configured to determine the time-varying reporting periodicity and/or the time-varying reporting validity time window based on one or more of:
statistical information of data collected or processed by the network entity for generating the notification reports,
statistical information of data or notifications received from a further network function for generating the notification reports,
statistical information of the notification reports reported to the consumer network function,
predicted information of data to be collected or processed by the network entity for generating upcoming notification reports,
predicted information of data or notifications to be received from the further network function for generating upcoming notification reports,
predicted information of the upcoming reports to be reported to the consumer network function
a desired accuracy related to the notification reports or subscribed request,
a desired energy efficiency or energy consumption information, and/or
a desired data sensitivity level.

In an embodiment, the network entity is further configured to receive the notification reports from a further network function related to the subscription request from the network function. The notification reports from a further network function includes the data required to process the notification reports or the final notification reports to the network function. Thus, the network entity may handle further processing of the notification reports from a further network function in an efficient manner.

In an embodiment, the network entity is further configured to provide the further network function with a time-varying adaptive data collection periodicity. For example, in an Analytics output generation, the data collection is the essential mechanism and further optimization of adaptive data collection periodicity controls signaling load and the associated energy consumption. Thus, the network entity may efficiently control the periodicity according to which the further network function is collecting data, in particular the data required for the notification reports.

In an embodiment, the network entity is configured to initially provide the notification reports to the network function with an initial reporting periodicity. Thus, the network entity may start sending the notification reports with a beneficial initial reporting periodicity.

In an embodiment, the network entity is configured to adjust the initial reporting periodicity and to provide the notification reports to the network function with the time-varying reporting periodicity and/or the time-varying reporting validity time window. Thus, the network entity may adjust the initial reporting periodicity due to, for instance, a changing environment.

In an embodiment, the time-varying reporting validity time window defines by when the network function is to receive the next notification report from the network entity.

In an embodiment, the network entity is further configured to negotiate the time-varying reporting periodicity with the network function. Thus, the network entity may ensure to use a time-varying reporting periodicity also acceptable for the network function.

In an embodiment, the subscription service provided in the mobile network by the network entity is related to QoS Monitoring, Analytics, data exposure and/or event exposure service operations.

In an embodiment, the notification reports comprise energy efficiency and/or energy consumption related information.

In an embodiment, the network entity is further configured to determine the energy efficiency or the energy consumption related information related to the time-varying reporting periodicity or the time-varying reporting validity time window.

According to a second aspect a method for providing a subscription service in a mobile network, wherein the method comprises:
receiving from a network function a subscription request for notification reports of the subscription service; and
providing notification reports to the network function with a time-varying, i.e. adaptive reporting periodicity and/or a time-varying, i.e. adaptive reporting validity time window.

The method according to the second aspect of the present disclosure can be performed by the network entity, e.g. network function, according to the first aspect of the present disclosure. Thus, further features of the method according to the second aspect of the present disclosure result directly from the functionality of the network entity according to the first aspect of the present disclosure as well as its different implementation forms described above and below.

According to a third aspect, a computer program product is provided, comprising a computer-readable storage medium for storing a program code which causes a computer or a processor to perform the method according to the second aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating a mobile communication network, in particular a core network of a mobile communication network including a network entity according to an embodiment for providing notification reports from a producer network function to a consumer network function with an adaptive notification periodicity;

FIG. 2 shows a schematic diagram illustrating conventional reporting mechanisms in a mobile communication network;

FIG. 3 shows a schematic diagram illustrating the interaction of the network entity according to an embodiment with a network function for negotiating an adaptive notification periodicity;

FIG. 4 shows a schematic diagram illustrating the interaction of the network entity according to an embodiment with a network function for notification reports with an adaptive notification periodicity;

FIG. 5 shows a schematic diagram illustrating the interaction of the network entity according to a further embodiment with a network function for notification reports with an adaptive notification periodicity;

FIG. 6 shows a signalling diagram illustrating the interaction between a network entity according to an embodiment in the form of a DCCF and a further network entity according to an embodiment in the form of a NWDAF for providing notification reports to a consumer network function with an adaptive notification periodicity;

FIG. 7 shows a signalling diagram illustrating the interaction between a network entity according to an embodiment in the form of a SMF and a consumer network function in the form of a UPF for providing N4 Session Level reporting notification reports to the UPF with an adaptive notification periodicity;

FIG. 8 shows a signalling diagram illustrating the interaction between a network entity according to an embodiment in the form of a NSACF and a further network entity according to an embodiment in the form of a NEF for providing notification reports including Network Slice related SLA parameters to a consumer network function in the form of an AF with an adaptive notification periodicity;

FIG. 9 shows a schematic diagram illustrating the input and the output of the network entity according to an embodiment for determining an adaptive notification periodicity;

FIGS. 10a-c show diagrams illustrating network slice load level measurements (FIG. 10a), a conventional periodic reporting scheme (FIG. 10b), and an adaptive reporting scheme implemented by a network entity according to an embodiment using an adaptive notification periodicity;

FIG. 11 shows a schematic diagram illustrating the implementation of a backward algorithm by a network entity according to an embodiment for determining an adaptive notification periodicity;

FIG. 12 shows a schematic diagram illustrating the input and the output of the network entity according to an embodiment for determining an adaptive notification validity time window;

FIGS. 13a-c show diagrams illustrating network slice load level measurements (FIG. 13a), a conventional periodic reporting scheme (FIG. 13b), and an adaptive reporting scheme implemented by a network entity according to an embodiment using an adaptive notification validity time window;

FIG. 14 shows a schematic diagram illustrating the implementation of a Long Short-term Memory (LSTM) Recurrent Neural Network (RNN) by a network entity according to an embodiment for determining an adaptive notification validity time window; and

FIG. 15 is a flow diagram illustrating a method for operating a network entity according to an embodiment.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, aspects of embodiments of the present disclosure or aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of method operations are described, a corresponding device may include one or a plurality of units, e.g. functional units, to perform the described one or plurality of method operations (e.g. one unit performing the one or plurality of operations, or a plurality of units each performing one or more of the plurality of operations), even if such one or more units are not explicitly described or illustrated in the figures. Moreover, if an apparatus is described based on one or a plurality of units, e.g. functional units, a corresponding method may include one operation to perform the functionality of the one or plurality of units (e.g. one operation performing the functionality of the one or plurality of units, or a plurality of operations each performing the functionality of one or more of the plurality of units), even if such one or plurality of operations are not explicitly described or illustrated in the figures. Further, it is understood that the features of the various exemplary embodiments and/or aspects described herein may be combined with each other, unless noted otherwise.

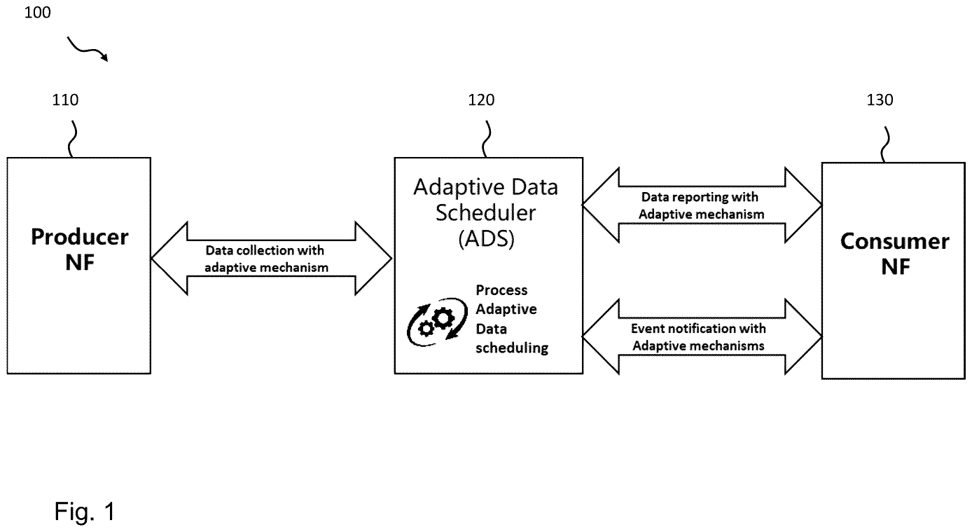

FIG. 1 shows a schematic diagram illustrating a mobile communication network 100, in particular a core network of a mobile communication network 100 including a network entity 120 according to an embodiment for providing notification reports from a producer network function 110 to a consumer network function 130 with a time-varying, i.e. adaptive reporting periodicity (which may also be expressed as a reporting frequency) and/or a time-varying, i.e. adaptive reporting validity time window. In the embodiment of FIG. 1 the network entity 120 is referred to as adaptive data scheduler (ADS) 110. In an embodiment, the network entity 120 may be a standalone network function implemented in the core network of the mobile communication network 100. According to further embodiments described in more detail below, the network entity 120 may be collocated with the producer network function 110 or implemented as a part thereof.

As will be described in more detail below, the network entity 120, e.g. ADS 120 supports adaptive mechanisms for subscription and notification service operations. In an embodiment, these adaptive mechanisms may be intended for the data collection from the producer NF 110 and for the data reporting or event notification to the consumer NF 130. The adaptive mechanisms may include adapting or adjusting the data collection frequency or rate, the data reporting frequency or rate and/or the notification periodicity or events. The adapting notification periodicity or events may also include the validity time window for the reported events or data. The validity time window represents the (expected) next data or event reporting time. The next data reporting may be triggered by the network entity 120 before the provided validity time window is expired, e.g., due to the detection of significant changes in the value to be notified or the significant changes of the required accuracy level.

As will be described in more detail below, the network entity 120, e.g. ADS 120 may determine the adaptive reporting frequency or the adaptive validity time window based on statistics or predictions of the previously collected data or reported data. In addition, the requirements of the subscription may also be considered by the network entity 120 in the determination process. The requirements of the subscription may include one or more of the followings: accuracy level, energy efficiency requirement, energy saving level and data sensitivity level.

As will be described in more detail below, the network entity, e.g. ADS 120 allows increasing the signalling load efficiency of the network operations and procedures by adjusting the adaptive reporting periodicity and/or the adaptive reporting validity time window over time and, thereby, for instance preventing unnecessary notification reports for the subscription request. Therefore, the network entity 120 may improve the energy efficiency and energy savings in a mobile communications network, in particular a 5G-A or 6G mobile communication network.

Before describing more detailed embodiments of the network entity 110 and the producer network function 120 for providing notification reports with an adaptive reporting frequency to the consumer network function 130, in the following some technical background as well as terminology will be introduced making use of one or more of the following abbreviations:
5G The fifth-generation technology standard for mobile network
5G-A The advanced fifth-generation technology standard for mobile network
6G The sixth-generation technology standard for mobile network
CN Core Network
AF Application Function
DCCF Data collection and coordination Function
SMF Session Management Function
NWDAF Network Data Analytics Function
UPF User Plane Function
NF Network Function
NSACF Network Slice Admission Control Function

As used herein, energy is understood in accordance with ITU-T L 1330, where energy is defined as “capacity for doing work; having several forms that may be transformed from one to another, such as thermal (heat), mechanical (work), electrical or chemical, expressed in Joules, Watt-hours (Wh) or kilo Watt-hours (kWh).”

Based on TS 28.554 and TS28.310, energy consumption is defined herein as the amount of energy which is utilized to achieve a system purpose expressed in Joule (J) or Watthour (Wh).

Based on ETSI ES 203 228 and ITU-T L 1330, the energy saving is defined herein as a feature which contributes to decreasing energy consumption as compared to the case when the feature is not implemented.

Based on the definition of energy efficiency used herein is based on ITU-T L 1330 and TS 28.554, the energy efficiency is defined as the relation between a useful output and energy consumption, in particular, SA5 defines a generic energy efficiency KPI in clause 6.7.4.1 as

$$Generic 5 GCEEKPI = \frac{Useful Output of 5 GC ( {UsefulOutput}_{5 GC} )}{Energy Consumption of 5 GC ( {EC}_{5 GC} )}$$

where “Useful Output of 5GC (UsefulOutput_{5GC})” denotes the useful output of 5GC (that can be defined differently, depending on which 5GC network functions are considered) and “Energy Consumption of 5GC (EC_{5GC})” denotes the Energy Consumption of 5GC. Basically, the Energy Efficiency is a KPI that is evaluated as a ratio between a performance metric and the Energy Consumption required to obtain that performance.

As used herein, signaling is defined as the use of signals for controlling communications service operations. This may include an information exchange concerning the establishment and control of service operations of the procedure.

As used herein, the signaling load is defined as the amount of signaling required to complete a process or procedure of one service operation.

As used herein, the accuracy is defined as the tolerance of the report or the collected value or the processed value defined by a unit value (e.g., ms, s, bits per second, etc.). The tolerance is the total allowable error that can be permitted from the based-line value. An example of the based-line value is the previous notification report. The terms accuracy or accuracy level are often used interchangeably.

As used herein, the sensitivity level or data sensitivity level is defined as an indication of how sensitive the data in the subscription and notification has to be. There is more than one level of sensitivity level. An example of (data) sensitivity levels can be low, middle, or high. The sensitivity level or data sensitivity level can be defined as a range for the desired time varying reporting periodicity or validity time window. The consumer NF may define the desired range which is the allowed minimum and the maximum reporting periodicity or validity time window. Based on the desired range, the producer NF determines a (time varying) reporting periodicity or validity time window value. If the determined (time varying) reporting periodicity or validity time window value is outside the range, the producer NF may negotiate with the consumer NF. The required sensitivity level of a subscription may be a factor to determine the notification.

As used herein, the adaptive validity time window is defined as the (expected) next reporting time. It is a time varying value and can also be considered the valid time periodic for the current report or reported data value or notification. The validity time window is usually associated with the notification report or reported data value.

As used herein, the adaptive reporting periodicity (or equivalently frequency] is defined as a time varying reporting periodicity and may be determined based on statistical or prediction information of the collected data or reported data.

As used herein, an adaptive data collection periodicity is defined as a time varying data collection periodicity and may be determined based on the statistical information of the collected data or prediction.

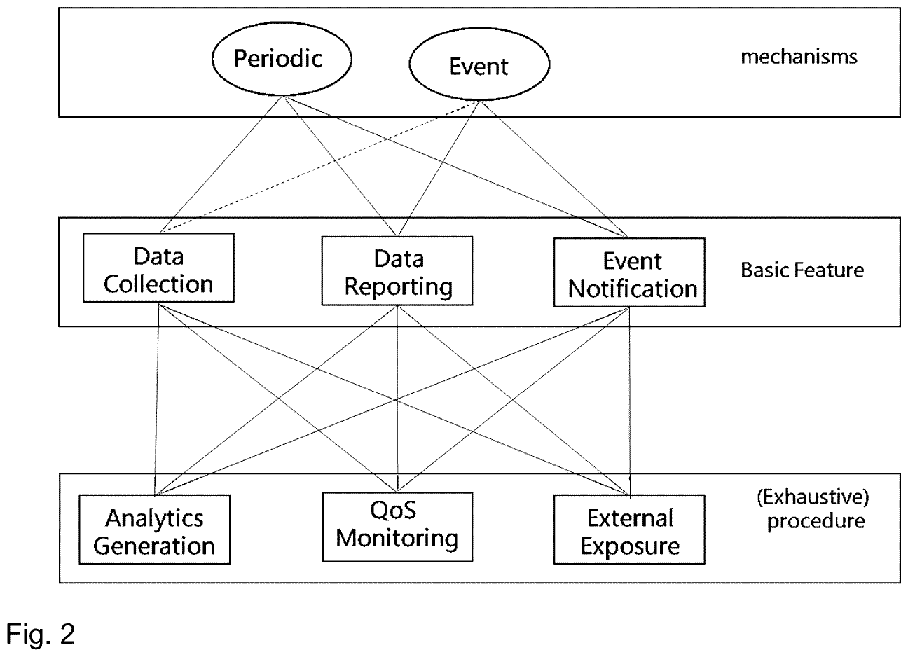

FIG. 2 shows a schematic diagram illustrating conventional reporting mechanisms in a mobile communication network. In an embodiment, FIG. 2 shows the basic subscription and notification service operations implemented as part of the CN procedures of a conventional mobile communication network. By way of example, the CN procedures illustrated in FIG. 2 are Analytics generation, QoS monitoring and (external) exposure which require the basic features of data collection, data reporting and event notifications. The subscription and notification service operations supporting those basic features include conventional periodic- or event-based mechanisms.

In a conventional ‘periodic-based’ mechanism, a consumer NF subscribes to a producer NF to notify a service operation periodically, e.g., every ‘x’ unit. Here ‘x’ may be any integer value and the unit may be milliseconds, seconds, minutes or hours. In a conventional ‘event-based’ mechanism, a consumer NF subscribes to a producer NF to notify a service operation based on one or more conditions. The producer NF notifies the subscribed event to the consumer NF only if the one or more conditions are met. In this case, the one or more conditions define a constraint for the event based subscription, which usually is defined by the consumer NF.

As will be appreciated, the static notification reports provided by a conventional ‘periodic-based’ mechanism constitute a simple scheme, which, however, in certain scenarios may lack efficiency and/or flexibility. For example, the producer NF sends the same notification, e.g., the same or similar value of the subscribed service operation to the consumer NF every ‘x’ unit although the repeated notification of the same or a very similar value is not necessary, i.e. redundant. Compared to the ‘periodic-based’ mechanism, the event-based mechanism is more efficient, for instance, with respect to the signaling load efficiency. However, the event reporting condition is fixed and is configured by the conditions so that only limited flexibility may be achieved. In either ‘periodic-based’ or ‘event-based’ mechanism, the configuration of the periodicity or event reporting condition is usually set by the consumer NF. In most cases, the consumer NF is not fully aware of the behavior of the report produced by the producer NF. As a result, the periodicity or the event reporting condition is not properly or well defined.

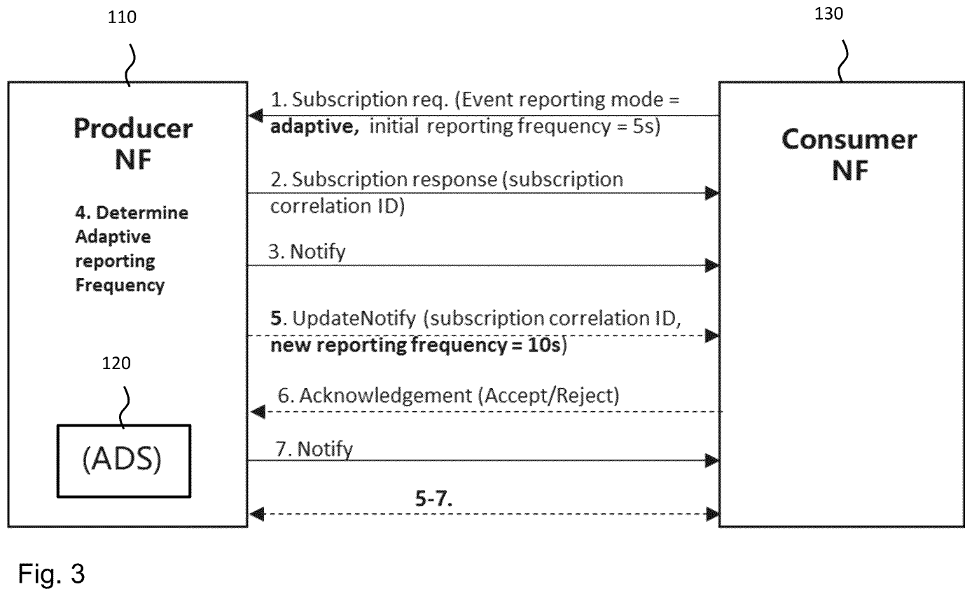

FIG. 3 shows a schematic diagram illustrating the interaction of the network entity 120, e.g. ADS 120 according to a further embodiment with the consumer network function 130 for negotiating an adaptive notification periodicity. As will be appreciated in the embodiment shown in FIG. 3, the network entity 120, e.g. ADS 120 is collocated or implemented as a component of the producer network function 110.

In the embodiment of FIG. 3, the network entity 120, e.g. ADS 120 implements an ‘adaptive’ reporting mode for the subscription and notification service operation. If the event reporting mode requested by the consumer NF 130 is the adaptive reporting mode, the time varying notification frequency and/or validity time window is determined by the ADS 120. The procedure of the adaptive subscription and notification service operations implemented by the ADS 120 in negotiation with the consumer NF 130 is described in the following.

In stage 1 of FIG. 3, the consumer NF 130 subscribes to the producer NF 110 implementing the ADS 120 with an event reporting mode=‘Adaptive’ and initial data reporting frequency, e.g., 5 s.

In stage 2 of FIG. 3, the Producer NF 110 implementing the ADS 120 responds to the subscription request by transmitting a subscription correlation ID to the consumer NF 130.

In stage 3 of FIG. 3, the Producer NF 110 implementing the ADS 120 notifies the subscribed event to the consumer NF 130 with an initial reporting frequency (e.g., every 5 s).

Meanwhile, in stage 4 of FIG. 3, the Producer NF 110 implementing the ADS 120 processes and determines the adaptive reporting frequency based on the statistics of the stored data and in an embodiment, the requirements (accuracy, energy consumption, data sensitivity level) if the subscription includes these requirements. Based on this input data, the Producer NF 110 implementing the ADS 120 may determine a new reporting frequency for the notification reports to the consumer NF 130, as will be described in more detail further below.

In stage 5 of FIG. 3, the producer NF 110 implementing the ADS 120 triggers the update notification to the consumer NF 130 with a new data collection frequency (e.g., 10s) using UpdateNotify service operation.

In stage 6 of FIG. 3, the consumer NF 130 responds to the UpdateNotify request with an Accept or Reject indication to the Producer NF 110 implementing the ADS 120.

If in stage 7 of FIG. 3 the Producer NF 110 implementing the ADS 120 accepts the new reporting frequency, the Producer NF 110 implementing the ADS 120 sends the next notification report to the consumer NF 130 in accordance with the new reporting frequency.

As will be appreciated, stages 5 to 7 of FIG. 3 may occur at any time if the Producer NF 110 implementing the ADS 120 determines to trigger a new reporting frequency and/or a new validity time window.

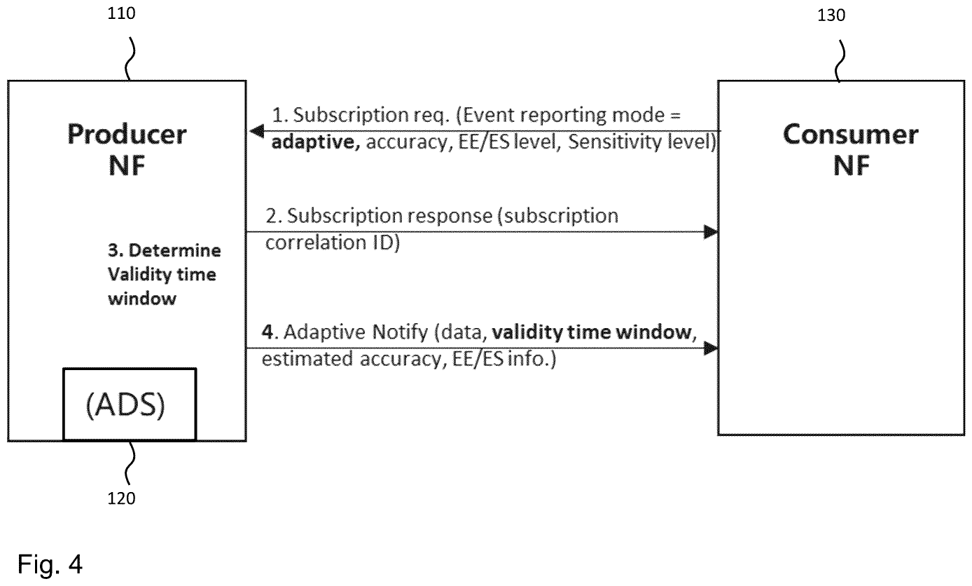

FIG. 4 shows a variant of the embodiment shown in FIG. 3 without negotiation of the adaptive reporting frequency.

In stage 1 of FIG. 4, the consumer NF 130 subscribes to the Producer NF 110 implementing the ADS 120 with an event reporting mode=‘Adaptive’. In addition, the subscription request may include the required accuracy, the required or desired energy efficiency level, the required or desired energy saving information and/or the sensitivity level indicating how the subscription event and related data is important. As will be appreciated, the sensitivity level indication may be different from the accuracy. The accuracy is related to the tolerance of the reports measured based on a unit value (e.g., ms, s, bits per second, etc.). The sensitivity level is related to the importance of the subscription request and the determination condition of the notification. For example, the subscription request related to URLLC services may have a higher sensitivity level than eMBB services in general cases.

In stage 2 of FIG. 4, the Producer NF 110 implementing the ADS 120 responds to the subscription request by returning a subscription correlation ID to the consumer NF 130.

Based on predictions and/or statistical information and inputs from the subscription request and the other related subscription requests, the Producer NF implementing the ADS 120 in stage 3 of FIG. 4 processes the notification and determines an adaptive reporting frequency (e.g., 10 s) and/or the validity time window as the (expected) next notification time to the consumer NF 130. The Producer NF 110 implementing the ADS 120 may further determine the (expected) data accuracy and the energy efficiency or energy saving information, e.g., energy consumption information.

Based on the previous stage, the Producer NF 110 implementing the ADS 120 triggers in stage 4 of FIG. 4 an adaptive notification to the consumer NF. In addition, the notification message to the consumer NF 130 may include the (expected) data accuracy and the energy efficiency or energy saving information, e.g., energy consumption information.

As already mentioned above, the validity time window represents the (expected) next data reporting time. In an embodiment, the next data reporting may be triggered before the provided validity time window has expired, for instance, due to significant changes of the required variance/accuracy level.

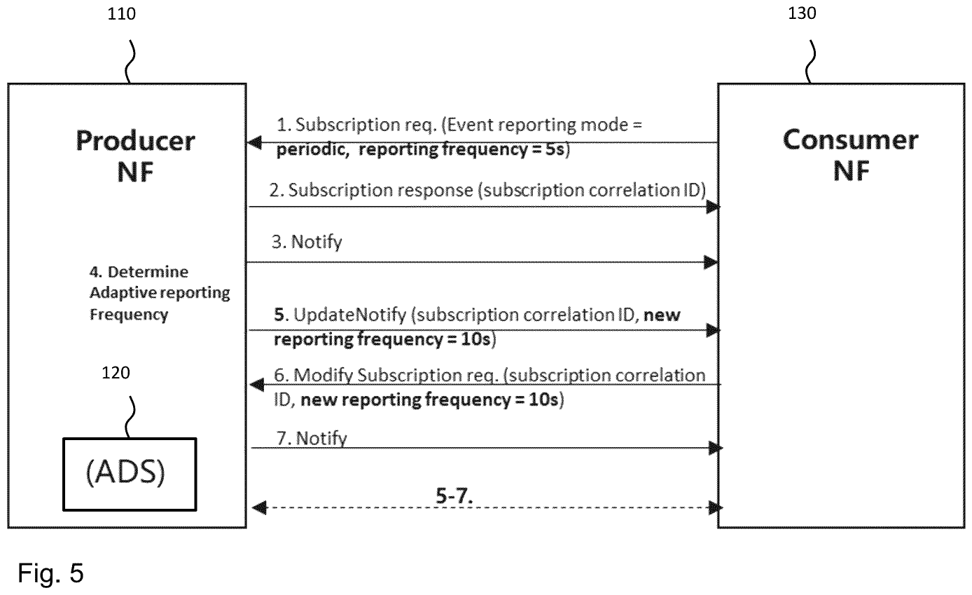

A further variant of the embodiments of FIGS. 3 and 4 is shown in FIG. 5.

In stage 1 of FIG. 5, the Producer NF 110 implementing the ADS 120 receives a subscription request (e.g., data collection, data exposure, Analytics subscription, QoS monitoring related subscription) with event reporting mode=“periodic” and reporting periodicity, e.g., 5s from the consumer NF 130.

In stage 2 of FIG. 5, the Producer NF 110 implementing the ADS 120 responds to the subscription request by returning a subscription correlation ID to the consumer NF 130.

In stage 3 of FIG. 5, the Producer NF 110 implementing the ADS 120 notifies the subscribed data to the consumer NF 130 periodically, for instance, every 5 seconds.

In stage 4 of FIG. 5, the Producer NF 110 implementing the ADS 120 determines the need for an adaptive reporting periodicity based on the statistics of the collected data related to the subscription. Based on this information, the Producer NF 110 implementing the ADS 120 determines a new (adaptive) reporting periodicity.

In stage 5 of FIG. 5, the Producer NF 110 implementing the ADS 120 triggers a negotiation of a new reporting periodicity with the consumer NF 130. This trigger may be part of one of the notification reports to the consumer NF 130. For a new trigger, a dedicated service operation, e.g., updateNotify service operation may be sent to the consumer NF 130 with a new reporting periodicity, e.g., 10s. Alternatively, the notification report may include the new reporting periodicity.

If the consumer NF 130 accepts the suggested new reporting periodicity, the modification of the subscription request is sent in stage 6 of FIG. 5 to the Producer NF 110 implementing the ADS 120 with the subscription correlation ID and the received reporting frequency or acceptance indication. The consumer NF 130 may reject the suggested reporting periodicity, e.g., based on the operator's policy or if other service requirements are not met.

In stage 7 of FIG. 5, the Producer NF 110 implementing the ADS 120 transmits notification reports to the consumer NF 130 based on the new reporting periodicity.

As will be appreciated, stages 5 to 7 of FIG. 5 may occur at any point in time, whenever a new reporting periodicity is determined by the Producer NF 110 implementing the ADS 120 according to stage 4 of FIG. 5.

As already described above, providing adaptive notification reports includes the determination of adaptive reporting frequency or validity time window by the ADS 120. In the following two algorithms are described that may be implemented by the ADS 120 for determining the adaptive reporting frequency or validity time window.

```
Algorithm: Determination of adaptive notifications for “Periodic-based” subscription and
notification.
Scenario: A data consumer (e.g., OAM) subscribes to the data producer (e.g., NWDAF) for an
Analytics (Network Slice Load Level (NSLL) analytics (e.g. number of active PDU Sessions))
with “Periodic” reporting mode.
Inputs:
  Periodicity time interval “T” (Required)
  Accuracy (%) (Required for A & C)
  Statistical data (e.g., Sampling data collected in NSLL Analytics) from time (t_i−n)−
  (t_i) (Required for B & C)
  Energy efficiency level (optional); Data sensitivity level (optional)
For each subscription, the data producer performs one of the followings:
Solution A:
1. measures the data to be reported at every time t_c, where t_c < T
2. Initially, the notification may be reported to the data consumer at time interval “T”
3. For each time interval “T”,
3.1. calculate the difference between the previous notified data value and the current data
value
3.2. notify the report to the data consumer if the difference is larger than the required accuracy
(e.g., the maximum percentage which can be different from the previous reported data)
3.3. Otherwise, no notification is sent to the data consumer.
Solution B:
1.-2. The same as solution A.
3. Analyze the sampling data collected from (t_i−n)−(t_i).
4. For each time interval “T_A” (note: T_A can be changed),
4.1. Compute T_A based on the sampling data collected at step 3 and the formulation provided
in slides 19, optionally required energy efficiency level and data sensitivity level.
5. Based on the (new) T_A value, the notification is sent to the data consumer.
Solution C:
1.-3. The same as solution B.
4. For each time interval “T”
4.1. Compute the prediction of the data (i.e., NSLL(T)) using LSTM model based on the
past/historical samples provide in slide 21.
4.2. Compute the estimated validity time window “T_V” for the next notification based on the
prediction at step 4.1, the required accuracy level, optionally required energy efficiency level
and data sensitivity level provided in slides 21.
5. If the need of notification before the previous provide “T_V” is required, the notification
with a new estimated T_V is sent to the data consumer.
Output:
  Adaptive notification (Required for A)
  Adaptive notification frequency (Required for B)
  (expected) Adaptive notification with validity time window (Required for C)
  Energy consumption information (Optional)
```

```
Algorithm: Determination of adaptive notifications for “Adaptive” Reporting subscription
Scenario: A consumer NF (e.g., OAM) subscribes to the provider NF (e.g., NWDAF) for an
Analytics (Network Slice Load Level (NSLL) analytics (e.g. number of active PDU Sessions))
with “Periodic” reporting mode.
Inputs:
  Accuracy (%) (Required)
  Statistical data (e.g., Sampling data collected in NSLL collection) from time (t_i−n) to
  time (t_i) (Required)
  Energy efficiency level (Optional)
  Data sensitivity level (Optional)
For each subscription, the data producer performs the followings:
1. measures the data to be reported at every time t_c, where t_c < T
2. Initially, the notification may be reported to the data consumer at time interval “T”
3. Analyze the sampling data collected from (t_i−n)−(t_i).
4. For each time interval “T”
4.1. Compute the prediction of the data (i.e., NSLL(T)) using LSTM model based on the
past/historical samples provide in slide 21.
4.2. Compute the estimated validity time window “T_V” for the next notification based on the
prediction at step 4.1, the required accuracy level, optionally required energy efficiency level
and data sensitivity level provided in slides 21.
5. If the need of notification before the previous provide “T_V” is required, the notification
with a new estimated T_V is sent to the data consumer.
Output:
  (expected) Adaptive notification with validity time window (Required)
  Energy consumption information (Optional)
```

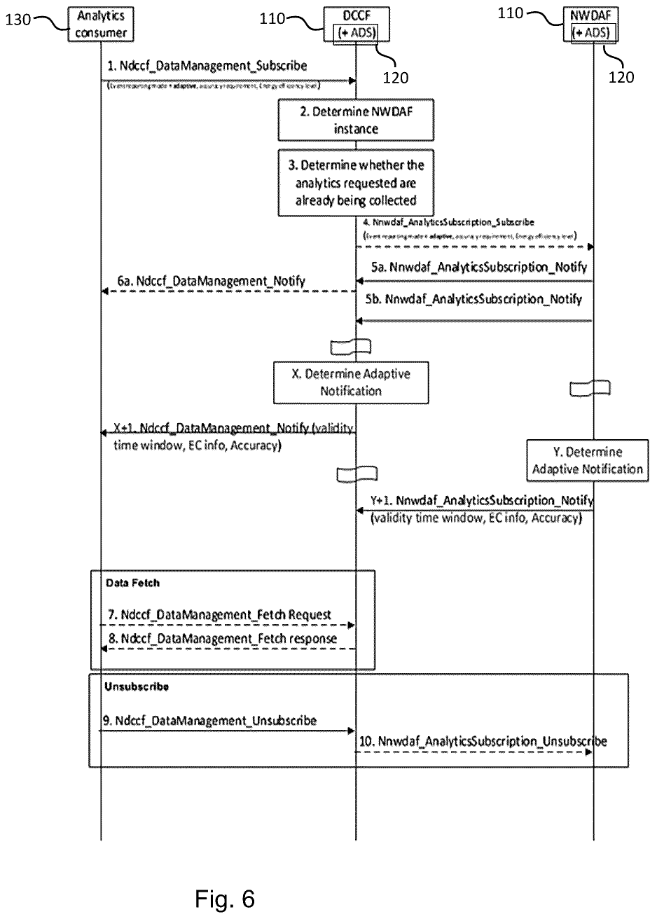

FIG. 6 shows a signalling diagram illustrating a further embodiment, where the ADS 120 is collocated with or implemented as a component of a DCCF 110 and a further ADS 120 is collocated with or implemented as a component of a NWDAF 110 for providing notification reports to the consumer network function 130 with an adaptive notification periodicity.

In stage 1 of FIG. 6, the Analytics consumer function 130 subscribes (e.g., DataManagement_Subscribe) to the DCCF 110 implementing the ADS 120 with “Adaptive” data reporting mode. The subscription request may include the required accuracy, the initial periodicity time interval T, energy efficiency level, energy saving information related to the data subscription.

In stage 2 and 3 of FIG. 6, the DCCF 110 determines the NWDAF 110 instance and whether the requested analytics have already been collected.

In stage 4 of FIG. 6, the DCCF 110 implementing the ADS 120 subscribes (e.g., AnalyticsSubscription_Subscribe) to the NWDAF 110 implementing the ADS 120 with “Adaptive” data reporting mode. The subscription includes the required accuracy, the initial periodicity time interval Tl (i.e., Tl<T), energy efficiency level, data sensitivity level related to the subscription and the message included in the subscription request included in stage 1 of FIG. 6.

In stage 5a and 5b of FIG. 6, the NWDAF 110 implementing the ADS 120 notifies the AnalyticsSubscription subscribe message to the DCCF 110 with initial periodicity time interval Tl.

In stage 6a of FIG. 6, the DCCF 110 implementing the ADS 120 notifies the DataManagment subscribe message to the Analytics consumer function 130 with initial periodicity time interval T.

In stage X of FIG. 6, the DCCF 110 implementing the ADS 120 processes the Adaptive notification and determines a new validity time window for the next notification report based on predictions and/or statistical information and input data from the subscription request. If a new validity time window is determined, it may be sent to the Analytics consumer NF 130 together with the current notification message.

In stage X+1 f FIG. 6, the DCCF 110 implementing the ADS 120 functionalities notifies the Analytics consumer NF 130 about the new validity time window. In an embodiment, the notification may include the associated accuracy and energy consumption level.

In stage Y of FIG. 6, the NWDAF 110 implementing the further ADS 120 independently processes the Adaptive notification and determines a new validity time window for the next report based on predictions and/or statistical information and input data from the subscription request. If a new validity time window is determined, it may be sent to the DCCF 110 together with the current notification message.

In stage Y+1 of FIG. 6, the NWDAF 110 implementing the further ADS 120 notifies the DCCF 110 about the new validity time window. In an embodiment, the notification message may include the associated accuracy and energy consumption information.

In stage 7 and 8 of FIG. 6, the Analytics consumer NF 130 requests to and receives from the DCCF 110 information about data fetch using the Ndccf_DataManagement_Fetch request and Ndccf_DataManagement_Fetch response.

In stage 9 of FIG. 6, the unsubscribe service operation Ndccf_DataManagement_Unsubscribe may take place between the Analytics consumer NF 130 and the DCCF 110.

In stage 10 of FIG. 6, the unsubscribe service operation Nnwdaf_AnalyticsSubscription_Unsubscribe may take place between the DCCF 110 and the NWDAF 110.

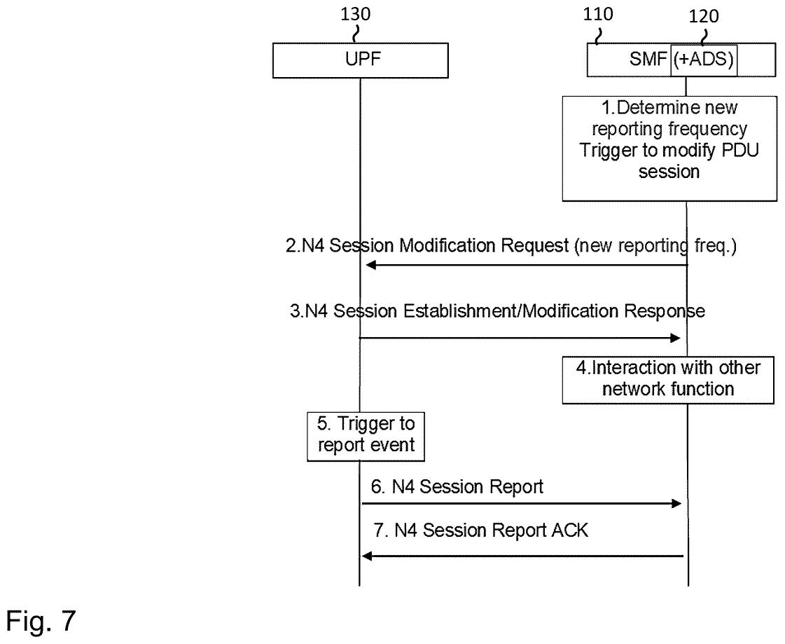

FIG. 7 shows a signalling diagram illustrating a further embodiment, where the ADS 120 is collocated with or implemented as a component of a SMF 110 and the consumer network function 130 is implemented in the form of a UPF 130 for providing N4 Session Level reporting notification reports to the UPF 130 with an adaptive notification periodicity.

In stage 1 of FIG. 7, the SMF 110 implementing the ADS 120 processes Adaptive data reporting frequency and determines a new reporting frequency based on predictions and/or statistical information of the received reports.

In stage 2 of FIG. 7, the SMF 110 implementing the ADS 120 sends a N4 session modification request with a new reporting frequency to the UPF 130.

In stages 3 of FIG. 7, the UPF 130 in response to the previous stage 2, sends a response of N4 session modification request with a new reporting frequency to the SMF 110. The response of N4 session modification request may include the indication of acceptance or rejection of the new reporting frequency.

In stage 4 of FIG. 7, the SMF 110 interacts with other network functions. In stage 5 and 6 of FIG. 7, the UPF 130 triggers the reporting event and starts N4 session report to the SMF 110. In stage 7 of FIG. 7, the SMF 110 acknowledges the reporting event to the UPF 130.

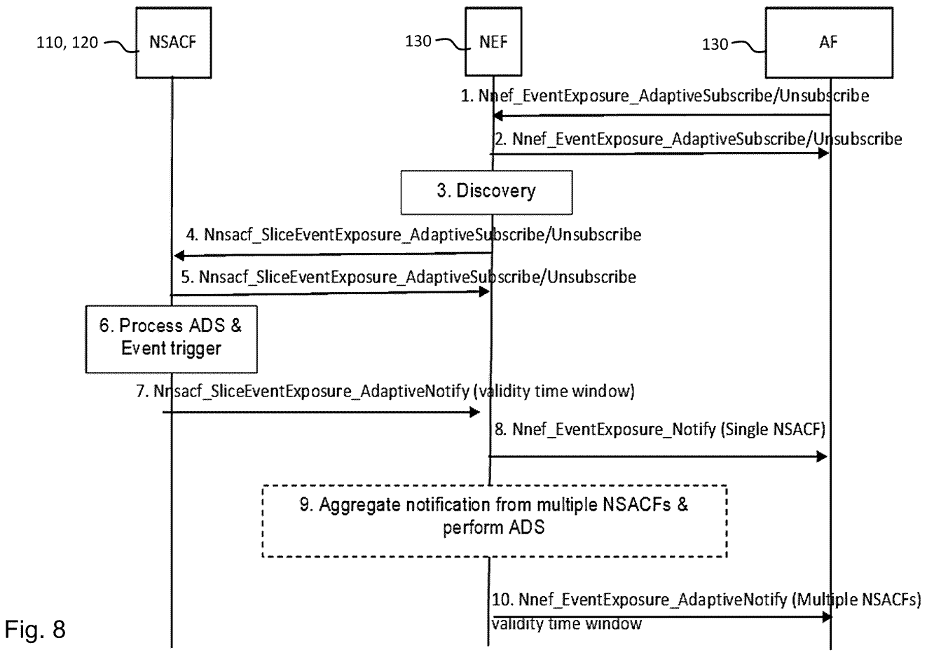

FIG. 8 shows a signalling diagram illustrating a further embodiment, where the ADS 120 is collocated with or implemented as a component of a NSACF 110 and a further ADS 120 is collocated with or implemented as a component of a NEF 110 for providing notification reports including Network Slice related SLA parameters to a consumer network function 130 in the form of an AF 130 with an adaptive notification periodicity.

In stage 1 of FIG. 8, the AF 130 subscribes to the NEF 110 with Adaptive subscription and notification.

In stage 2 of FIG. 8, the NEF 110 acknowledge the subscription request to the AF 130.

In stage 3 of FIG. 8, the NEF 110 subscribes to the NSACF 110 with Adaptive subscription and notification.

In stage 4 of FIG. 8, the NSACF 110 acknowledge the subscription request to the NEF 110.

In stage 5 of FIG. 8, the NSACF 110 implementing the ADS 120 determines the validity time window.

In stage 6 of FIG. 8, the NSACF 110 triggers adaptive Notification with the validity time window to the NEF 110.

In case of multi-NSACF cases, the NEF 110 implementing the ADS 120 may perform in stage 7 of FIG. 8 aggregation of network slice exposure data from each NSACF 110 and determine the validity time window.

In stage 8 of FIG. 8, the NEF triggers 110 adaptive Notification with the validity time window to the AF 130.

As already described above, the producer NF 110 (which may implement the ADS 120) or the consumer NF 130 may be any 5GC NF defined in TS23.501. Any subscription and notification service operation between any two 5GC NFs is applicable.

In the following some further more detailed embodiments for the adaptive notification implemented by the network entity 120, e.g. ADS 120 will be described for the example of reporting network slice load level (NSLL) Analytics. As will be appreciated, however, for other types of data to be reported the concepts described in the following are the same.

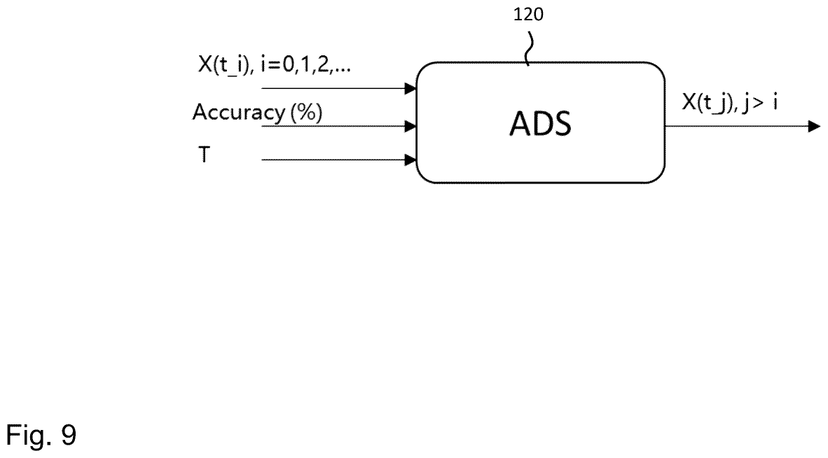

FIG. 9 shows a schematic diagram illustrating the input and the output of the network entity 120, e.g. ADS 120 according to an embodiment for determining an adaptive notification periodicity in real-time. In the embodiment shown in FIG. 9 the ADS 120 implements a real-time algorithm for providing an adaptive notification based on the inputs: statistical data (e.g., sampling data until the time instance (t_i), the required accuracy, and (initial) periodicity time interval for notification). As shown in FIG. 9, the ADS 120 is configured to receive the statistics of sampled data (e.g., to generate network slice load level (NSLL) analytics), the required accuracy in percentage and the initial periodicity time interval T. Based on the required accuracy, the statistical data of NSLL and the current generated NSLL, the ADS 120 determines the adaptive notification in real-time. As long as the current generated NSLL fulfils the required accuracy, e.g., the difference between the previous NSLL value and the current generated NSLL value is lower than the accuracy value, the ADS 120 may determine not to send the notification to the consumer NF 130. If the difference is higher than the accuracy value, the ADS 120 may trigger the notification report to the consumer NF 130.

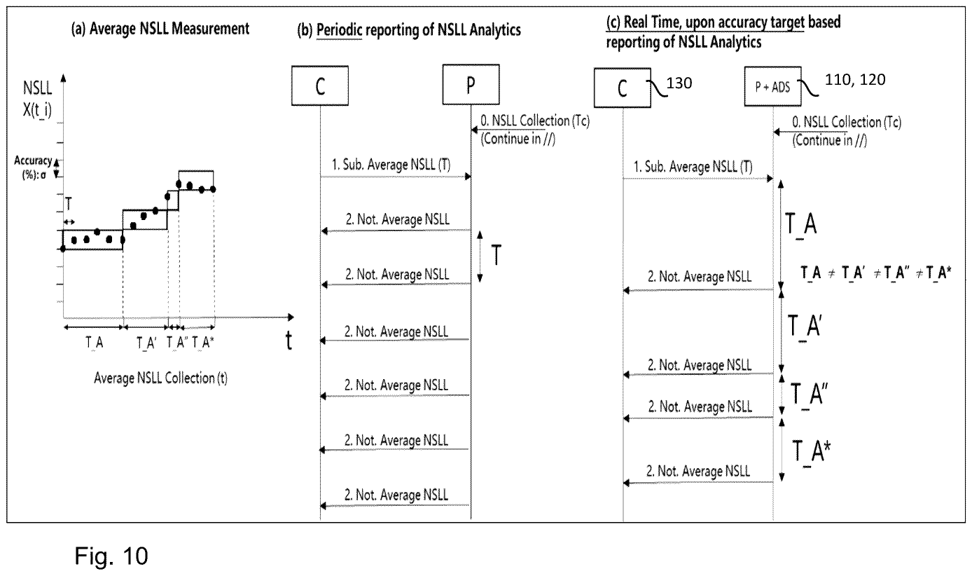

FIGS. 10a-c show diagrams illustrating network slice load level measurements (FIG. 10a), a conventional periodic reporting scheme (FIG. 10b), and an adaptive reporting scheme implemented by the network entity 120, e.g. ADS 120 according to an embodiment using an adaptive notification periodicity in real-time. For a given average NSLL measurement (i.e., input sampled data, FIG. 10a), the conventional periodic mechanism notifies to the consumer NF (i.e., C) at every T interval (FIG. 10b). In the real-time mechanism implemented by the ADS 120 according to an embodiment (FIG. 10c), the ADS 120 monitors the current NSLL data and the previous notified NSLL at every time interval T and determines whenever the value is in the provided accuracy range compared to the previous value or not. If the difference between the current NSLL value and the previous NSLL values is larger than the accuracy range, the adaptive notification is triggered. For example, as depicted in FIG. 10c, the ADS 120 observes that at time T_A, the NSLL value is not satisfying the accuracy range compared to the previous value (as illustrated in FIG. 10a), the adaptive notification is sent to the consumer NF 130 (see step 2 of FIG. 10c). Afterwards, the next adaptive notification is sent at T_A′ when the accuracy violation occurs. As will be appreciated, the times when the adaptive notifications are sent i.e., T_A and T_A′ are not equal, representing adaptive, i.e. non-periodic reporting as implemented by the ADS 120.

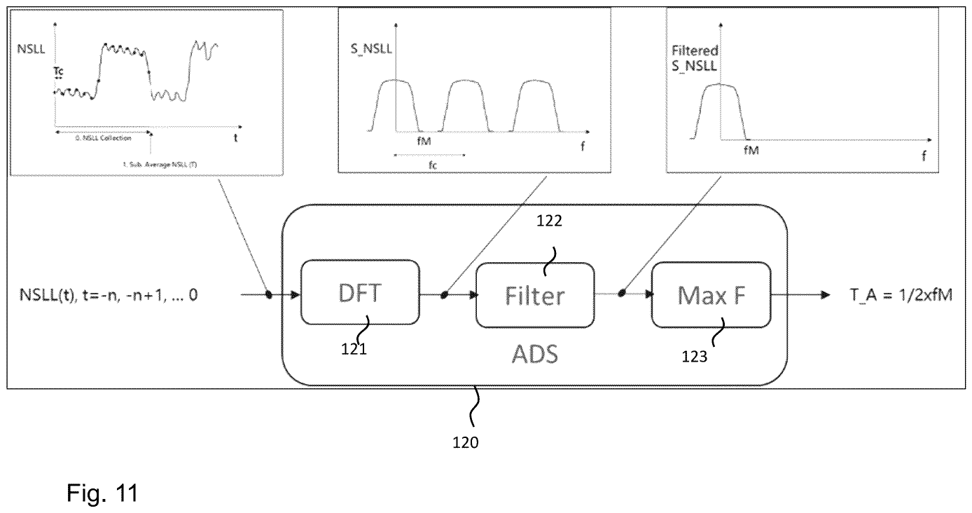

FIG. 11 shows a schematic diagram illustrating the implementation of a backward algorithm by the network entity 120, e.g. ADS 120 according to an embodiment for determining an adaptive notification periodicity. The backward algorithm implemented for ADS 120 calculates the adaptive reporting frequency based on statistical data (e.g., sampling data until the time instance (t_i), the required accuracy and the time interval T). An exemplary implementation of a backward-based ADS 120 may use a Discrete Fourier Transform (DFT) block 121. By converting a finite sequence of sampled input data i.e., NSLL (t) in the time domain to the sequence of same length in the frequency domain, the ADS 120 can determine the maximum frequency required (i.e., fM) to avoid losing information. In the determination process, the resulting frequency domain signal is then passed through a filter 122 to remove the unwanted frequencies and provides the signal with cutoff frequency fM as an output (block 123 shown in FIG. 11). The fM here is the adaptive reporting frequency, with which the time for reporting the adaptive notification can be determined as

$$\frac{1}{2 fM} .$$

In this case, the ADS 120 determines a new reporting frequency for the consumer NF 130 to improve the efficiency of subscription and notification service operations. Basically, the ADS 120 with backward mechanism determines a new reporting frequency based on the statistical data and can be used for a long time. It means a change of new reporting frequency is not very frequent.

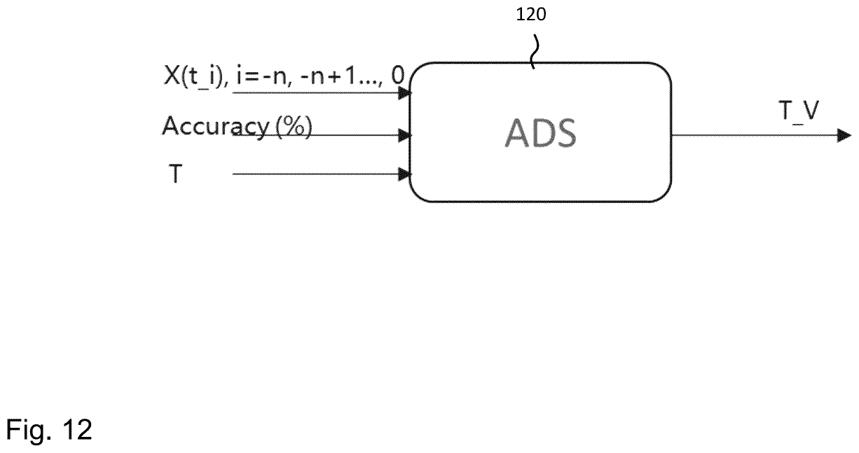

FIG. 12 shows a schematic diagram illustrating the input and the output of the network entity 120, e.g. ADS 120 according to a further embodiment for determining an adaptive notification validity time window based on a forward algorithm. As shown in FIG. 12, the forward algorithm uses NSLL data for past timestamps, the accuracy requirement in percentage and the sampling period T to determine the validity time window.

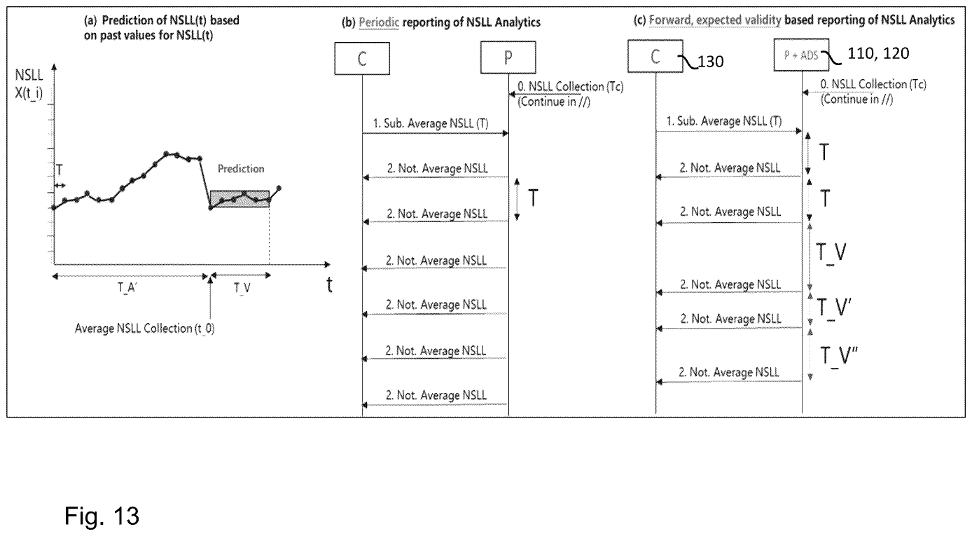

FIGS. 13a-c show diagrams illustrating network slice load level measurements (FIG. 13a), a conventional periodic reporting scheme (FIG. 13b), and the adaptive reporting scheme implemented by the network entity 120, e.g. ADS 120 according to an embodiment for the forward algorithm implementation illustrated in FIG. 12. As will be appreciated, the conventional periodic reporting (shown in FIG. 13b) sends the adaptive notifications periodically depending on the sampling period T. However, with the forward algorithm implemented by the ADS 120 according to an embodiment, the values of NSLL are predicted for a prediction horizon (PH) (PH may be the number of timestamps for which the prediction is performed), as shown in FIG. 13a. These predicted NSLL values are then analyzed by the ADS 120 according to an embodiment based on the required accuracy requirement. Whenever the value of NSLL violates the accuracy requirement, the period until that timestamp is considered at validity time window (i.e., T_V). The process continues until the next violation occurs. For example, as depicted in FIG. 13c, the next violation occurs at T_V′, which will be reported as validity time window by the ADS 120 according to an embodiment. As will be appreciated, T_V and T_V′ may or may not be equal.

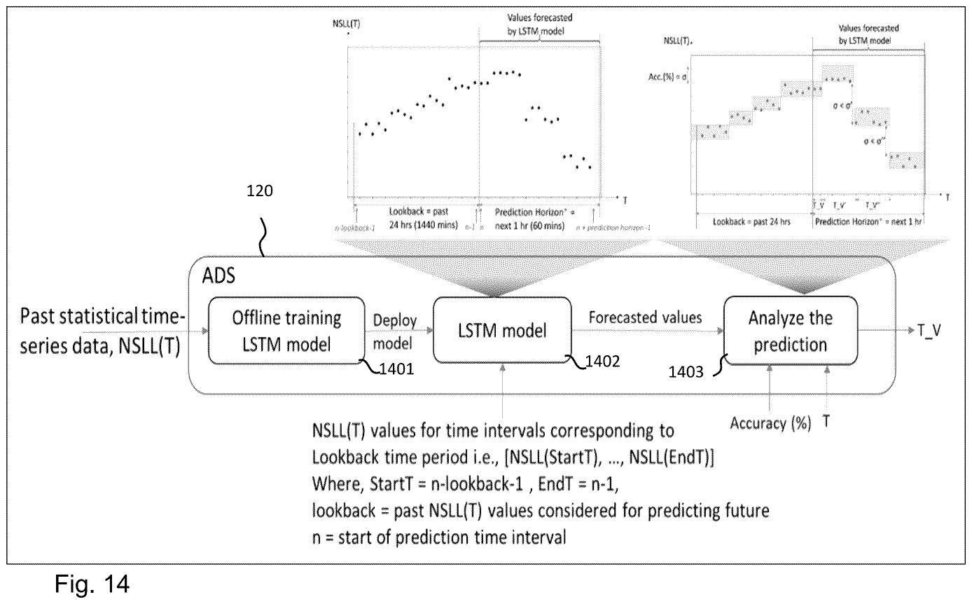

FIG. 14 shows a schematic diagram illustrating the implementation of a Long Short-term Memory (LSTM) Recurrent Neural Network (RNN) by the network entity 120, e.g. ADS 120 according to an embodiment for determining an adaptive notification validity time window. In an embodiment, in the embodiment shown in FIG. 14 the ADS 120 is configured to implement Long Short-term Memory, LSTM, model 1402 for prediction of NSLL values. The LSTM model 1402 is trained using the past statistical NSLL data and deployed once trained (see stage 1401 of FIG. 14). To perform the prediction, the LSTM model 1402 is fed with a number of past NSLL (T) values, referred as lookback. The exemplary lookback is 24 hrs (i.e., 1440 minutes) in FIG. 14. The LSTM model 1402 performs multi-step prediction for a PH of 60 mins (i.e., one value for each minute). Once the values are predicted, they will be analyzed to determine the validity window and send the notification accordingly (see stage 1403 of FIG. 14). For a given accuracy range of σ, if the difference between the two values is greater than σ, then that timestamp is considered to send the adaptive notification. Thereby, the period between sending the two adaptive notifications is considered as validity window, denoted by T_V, T_V′, T_V″ in FIG. 14.

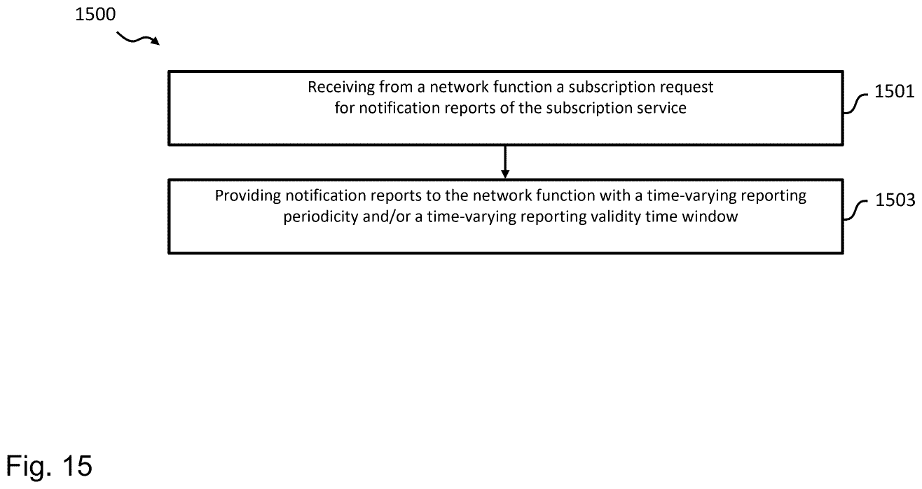

FIG. 15 is a flow diagram illustrating a method 1500 for operating a network entity, such as the network entity 120, in particular ADS 120 of FIG. 1 for providing a subscription service in the mobile communication network 100. The method 1500 comprises a operation 1501 of receiving from the consumer network function 130 a subscription request for notification reports of the subscription service Moreover, the method 1500 comprises a operation 1503 of providing notification reports to the consumer network function 130 with an adaptive time-varying reporting periodicity and/or an adaptive time-varying reporting validity time window.

The method 1500 can be performed by the network entity 120 according to an embodiment. Thus, further features of the method 1500 result directly from the functionality of the network entity 120 as well as the different embodiments thereof described above and below.

One of ordinary skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present disclosure, it should be understood that the disclosed system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units may be integrated into one unit.

1. A network entity for providing a subscription service in a mobile network, the network entity comprising:
a processor, and
a memory coupled to the processor to store instructions, which when executed by the processor, cause the network entity to:
receive from a network function a subscription request for notification reports of the subscription service; and
provide notification reports to the network function with a time-varying reporting periodicity and/or a time-varying reporting validity time window.

2. The network entity of claim 1, wherein the subscription request is a for notification reports with a time-varying reporting periodicity and/or a time-varying reporting validity time window.

3. The network entity of claim 1, wherein the subscription request comprises an indication for notification reports with a time-varying reporting periodicity and/or a time-varying reporting validity time window.

4. The network entity of claim 1, wherein the subscription request comprises one or more of: an initial reporting periodicity, a desired accuracy related to the reporting or subscribed request, a desired energy efficiency information, a desired energy consumption information, or a desired data sensitivity level.

5. The network entity of claim 1, wherein the instructions, when executed, further cause the network entity to:
determine the time-varying reporting periodicity and/or the time-varying reporting validity time window.

6. The network entity of claim 5, wherein the instructions, when executed, further cause the network entity to:
determine the time-varying reporting periodicity and/or the time-varying reporting validity time window based on one or more of:
statistical information of data collected or processed by the network entity for generating the notification reports,
statistical information of data or notifications received from a further network function for generating the notification reports,
statistical information of the notification reports reported to the network function,
predicted information of data to be collected or processed by the network entity for generating upcoming notification reports,
predicted information of data or notifications to be received from the further network function for generating upcoming notification reports,
predicted information of the upcoming reports to be reported to the network function,
a desired accuracy related to the notification reports or subscribed request,
a desired energy efficiency or energy consumption information, or
a desired data sensitivity level.

7. The network entity of claim 1, wherein the instructions, when executed, further cause the network entity to:
receive the notification reports from a further network function related to the subscription request from the network function.

8. A method for providing a subscription service in a mobile network, comprising:
receiving from a network function a subscription request for notification reports of the subscription service; and
providing notification reports to the network function with a time-varying reporting periodicity and/or a time-varying reporting validity time window.

9. The method of claim 8, wherein the subscription request is a request for notification reports with a time-varying reporting periodicity and/or a time-varying reporting validity time window.

10. The method of claim 8, wherein the subscription request comprises an indication for notification reports with a time-varying reporting periodicity and/or a time-varying reporting validity time window.

11. The method of claim 8, wherein the subscription request comprises one or more of: an initial reporting periodicity, a desired accuracy related to the reporting or subscribed request, a desired energy efficiency information, a desired energy consumption information, or a desired data sensitivity level.

12. The method of claim 8, further comprising:
determining the time-varying reporting periodicity and/or the time-varying reporting validity time window.

13. The method of claim 12, wherein determining the time-varying reporting periodicity and/or the time-varying reporting validity time window based on one or more of:
statistical information of data collected or processed by a network entity for generating the notification reports,
statistical information of data or notifications received from a further network function for generating the notification reports,
statistical information of the notification reports reported to the network function,
predicted information of data to be collected or processed by the network entity for generating upcoming notification reports,
predicted information of data or notifications to be received from the further network function for generating upcoming notification reports,
predicted information of the upcoming reports to be reported to the network function,
a desired accuracy related to the notification reports or subscribed request,
a desired energy efficiency or energy consumption information, or
a desired data sensitivity level.

14. The method of claim 13, further comprising:
receiving the notification reports from a further network function related to the subscription request from the network function.

15. A non-transitory machine-readable storage medium having instructions stored therein, which when executed by a processor, cause the processor to:
receive from a network function a subscription request for notification reports of the subscription service; and
provide notification reports to the network function with a time-varying reporting periodicity and/or a time-varying reporting validity time window.

16. The machine-readable storage medium of claim 15, wherein the subscription request is a request for notification reports with a time-varying reporting periodicity and/or a time-varying reporting validity time window.

17. The machine-readable storage medium of claim 15, wherein the subscription request comprises an indication for notification reports with a time-varying reporting periodicity and/or a time-varying reporting validity time window.

18. The machine-readable storage medium of claim 15, wherein the subscription request comprises one or more of: an initial reporting periodicity, a desired accuracy related to the reporting or subscribed request, a desired energy efficiency information, a desired energy consumption information, or a desired data sensitivity level.

19. The machine-readable storage medium of claim 15, wherein the instructions, when executed, further cause the processor to:
determine the time-varying reporting periodicity and/or the time-varying reporting validity time window.

20. The machine-readable storage medium of claim 19, wherein the instructions, when executed, further cause the processor to:
determine the time-varying reporting periodicity and/or the time-varying reporting validity time window based on one or more of:
statistical information of data collected or processed by a network entity for generating the notification reports,
statistical information of data or notifications received from a further network function for generating the notification reports,
statistical information of the notification reports reported to the network function,
predicted information of data to be collected or processed by the network entity for generating upcoming notification reports,
predicted information of data or notifications to be received from the further network function for generating upcoming notification reports,
predicted information of the upcoming reports to be reported to the network function,
a desired accuracy related to the notification reports or subscribed request,
a desired energy efficiency or energy consumption information, or
a desired data sensitivity level.
